(19) United States
(12) Patent Application Publication
(10) Pub. No.: US 2009/0034112 A1
(43) Pub. Date: Feb. 5, 2009

(54) METHODS AND APPARATUS TO VARY INPUT IMPEDANCE OF A HARD DISK DRIVE READ PREAMPLIFIER

(75) Inventor: Motomu Hashizume, Tokyo (JP)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/831,750

(22) Filed: Jul. 31, 2007

(51) Int. Cl. G11B 5/02

(52) U.S. Cl. 360/67

(57) ABSTRACT

Methods and apparatus to vary the input impedance of a hard disk read preamplifier are disclosed. A disclosed method amplifies a read signal from a hard disk read head based on the impedance presented by the read head and changes the impedance presented to the read head based on the gain factor.

### TECHNICAL FIELD

The present disclosure pertains to hard disk drives and, more particularly, to methods and apparatus to vary input impedance of a hard disk drive read preamplifier.

### BACKGROUND

A hard disk drive system stores digital data on a magnetic medium by magnetizing portions of a surface. To read information from the medium, a read head, such as a giant magneto-resistive (GMR) head, rests above the surface of the magnetic medium to detect magnetic fields due to stored information on the medium. The read head is mounted onto an actuator arm that moves radially across the surface of the hard disk while the hard disk spins, thus allowing the read head to read each magnetic field on the disk. The read head is excited by electromagnetic fields resulting from the information stored on the medium to generate a read signal.

The electromagnetic read signal detected via the read head is very weak and a preamplifier is placed as close to the read head as possible to prevent noise from being introduced into the read signal. Thus, a preamplifier is placed on the actuator arm and is coupled to the read head via a transmission line. However, the output impedance of the read head varies based on the read signal. Accordingly, to prevent reflection of the read signal from the preamplifier to the read head and maximize signal transfer, the input impedance of the preamplifier must be adjusted based on the impedance of the read head. One method of altering the input impedance of a hard drive write preamplifier is to use a feedback circuit to create a negative resistance to adjust the input impedance of the preamplifier.

### BRIEF DESCRIPTION OF THE DRAWINGS

FIG. 1 is a block diagram of an example hard disk read system.

FIG. 2 is a block diagram of an example preamplifier of FIG. 1.

FIG. 3 is schematic illustration of an example preamplifier of FIG. 1.

FIG. 4 is a diagram illustrating the input impedance characteristic of the preamplifier of FIGS. 1-3.

FIG. 5 is another example of a schematic illustration of an example preamplifier of FIG. 1.

### DETAILED DESCRIPTION

Generally, methods and apparatus to vary input impedance of a hard disk drive read head are disclosed. According to one example, a circuit implements a current divider to adjust gain and vary the input impedance of the hard disk drive preamplifier.

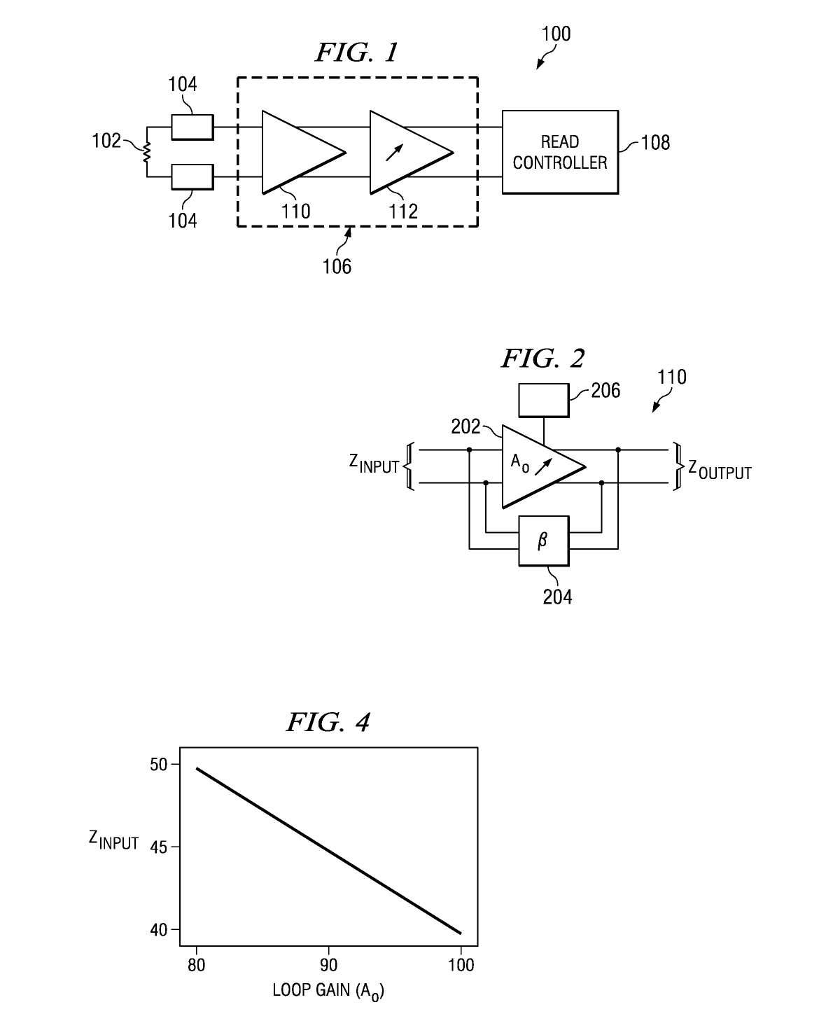

FIG. 1 illustrates a block diagram of an example hard disk drive read system 100. The example hard disk drive read system 100 includes a read head 102 that communicates a read signal via transmission lines 104 to an amplifier 106, which may be a differential amplifier to prevent noise from being introduced into the read signal. The output of amplifier 106, which is an amplified read signal, is provided to a hard disk read controller 108 for data processing. As shown in FIG. 1, the amplifier 106 includes a preamplifier 110 and a variable gain amplifier 112. The preamplifier 106 is generally a very low noise, high gain amplifier to prevent noise from being introduced into the read signal. The variable gain amplifier 112 further amplifies the read signal provided by the preamplifier 106 in preparation for data processing by the hard drive read controller 108. As described below, the preamplifier 110 varies the gain based on the read signal to vary input impedance so that the input impedance of 110 matches the impedance of the read head 102 and the transmission line 104.

FIG. 2 illustrates an example preamplifier 110 to vary the input impedance presented to the read head 102. Generally, the preamplifier 110 has a gain circuit 202, a feedback circuit 204, and a power supply 206. Discuss Zin and Zout. The gain circuit 202, which may one of many amplification stages, provides the initial gain of the preamplifier 110. The feedback circuit 204, using a portion of the amplified read signal, conveys the portion of the read signal to the input of the gain circuit 202. In the example of FIG. 2, the gain circuit 202 receives the voltage of the read signal and amplifies the read signal by a gain factor for later processing by the hard disk read controller 108. The gain factor of the gain circuit 202 is labeled as A_{O} and is also referred to as the open loop gain of the gain circuit 202. In addition, the gain circuit 202 is configurable to adjust the gain factor A_{O} applied to the read signal based on the amplitude of the read signal provided via the read head 102 and transmission lines 104. In other words, based on the impedance presented by the read head 102 and the transmission line 104, the gain circuit 202 adjusts the input impedance of the amplifier 110 by changing the gain factor A_{O} used to amplify the read signal.

After the read signal is amplified by the gain factor A_{O}, a portion of the amplified read signal is fed back into the input of the gain circuit 202 by the feedback circuit 204. In the example of FIG. 2, the feedback circuit 204 may improve the performance of the gain circuit 202. For example, the feedback circuit 204 may improve bandwidth performance of the preamplifier 110, may control the input impedance (Z_{INPUT}) presented by the preamplifier 110 to the read head 102 and transmission lines 104, and may desensitize the preamplifier 110 to variations of circuit devices (e.g., transistors, resistors, capacitors, etc.). As illustrated in the example of FIG. 2, the portion of the amplified read signal that is conveyed to the input of the gain circuit 202 is based on the feedback factor, β. The feedback circuit 204 forms an alternative communication path (i.e., a feedback loop) from the output of the gain circuit 202 to the input of the gain circuit 202, thereby forming a shunt-shunt feedback network. A shunt-shunt feedback network is a transresistance network that affects the input impedance (Z_{INPUT}) and the output impedance (Z_{OUTPUT}) presented by the preamplifier 110.

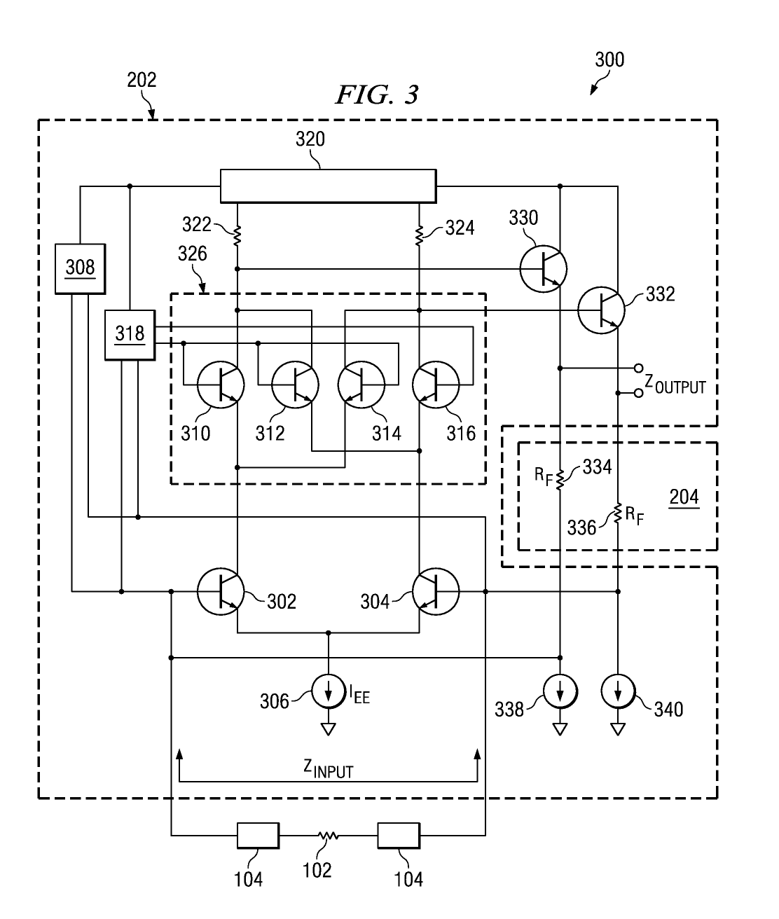

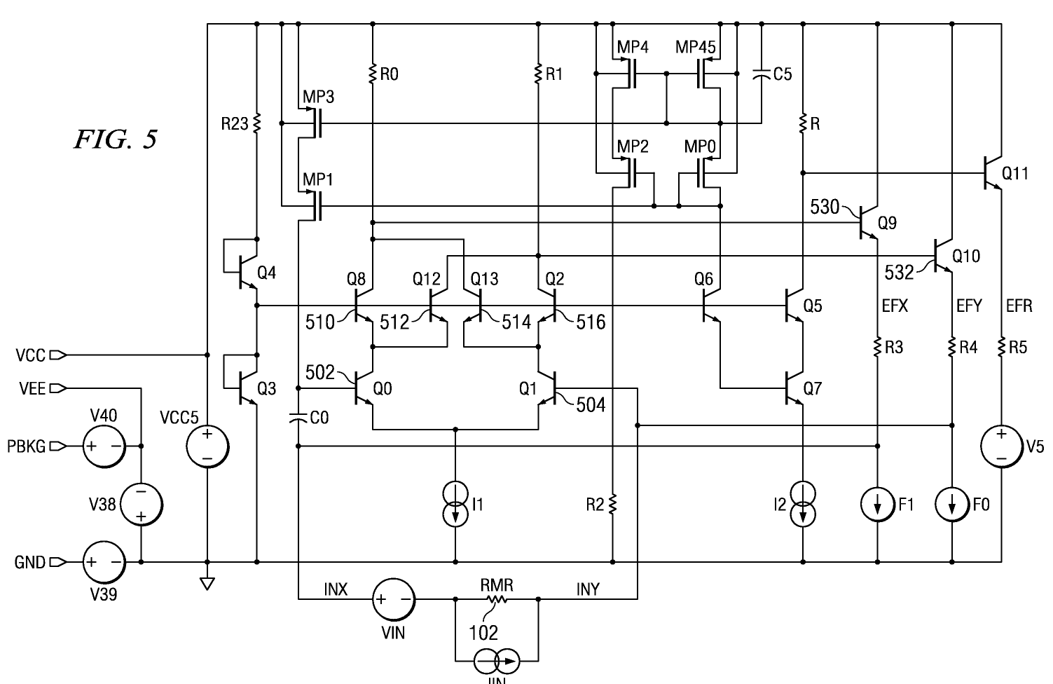

FIG. 3 is a schematic representation of an example circuit 300 to implement one stage of the gain circuit 202 including an example feedback circuit 204. The gain circuit 202 is an amplifier configured to sense the voltage of the read signal and convert the voltage into a current. To sense the voltage, a first and second transistor 302 and 304 are configured to receive the differential read signal input from the read head 102 via the transmission lines 104. In the example of FIG. 3, any transistor of the gain circuit 202 may be of any active device (e.g., an N-channel transistor, a P-channel transistor, an N-channel metal-oxide field effect transistor (FET), a P-channel FET, etc.). The first and second transistors 302 and 304 are coupled via their emitters to a current source 306. The current sink source 306 sinks a predetermined amount of current (I_{EE}) to a low voltage node such as a ground (e.g., a ground, a system ground, a negative voltage supply, etc.). The bases of the first and second transistors 302 and 304 receive the differential read signal from the read head 102. The transistors 302 and 304 amplify the current of the input read signal to produce emitter currents that feed the current source 306. Additionally, the bases of the transistors 302 and 304 are biased via a direct current (DC) bias 308 that is further coupled to a power supply 320. For example, the DC bias 308 may generate a predetermined amount of current to bias transistors 302 and 304 based on the current source 306 (i.e., the DC bias 308 biases transistors 302 and 304 to pull one half of the current source 306, I_{EE}).

The collector of transistor 302 is coupled with the emitter of transistor 310 and the emitter of transistor 314. The collector of transistor 304 is coupled with the emitter of transistor 312 and the emitter of transistor 316. The bases of the transistors 310 and 316 are coupled to a first output of a DC bias 318 that is further coupled to the power supply 320. A second output of DC bias 318 is also coupled to the base of transistors 312 and 314, which biases transistors 312 and 314 based on the magnitude of the differential read signal. As illustrated in the example of FIG. 3, the DC bias 318 is coupled with the bases of transistors 302 and 304. To provide collector currents to transistors 310 and 316, the power supply 320 is coupled with the collectors of transistors 310 and 316 via resistors 322 and 326, respectively.

In the example of FIG. 3, transistors 302 and 304 form a differential common-emitter pair and transistors 310 and 316 form a differential common-base pair. Persons having ordinary skill in the art will readily recognize a common-emitter stage followed by a common-base stage forms a cascode amplifier, which improves the high frequency performance of the transistors by reducing capacitance associated with the transistors. In the cascode configuration, the transistors 302 and 304 provide the initial amplification of the read signal that is applied to the bases of transistors 302 and 304. The transistors 302 and 304 amplify the read signal, resulting in collector currents in transistors 302 and 304. Thus, the read signal is amplified by the gain factor Ao (the open loop gain), which is based on the transconductance (gₘ) of the transistors 302 and 304 and the resistance of the resistors 322 and 324.

The second stage of the cascode amplifier is the common-base pair formed by transistors 310 and 316. The amplified read signal is received by the emitter of transistors 310 and 316 and the read signal is conveyed to the output of the cascode amplifier via the collectors of transistors 310 and 316. Persons having ordinary skill in the art will readily appreciate that a common-base transistor configuration is a current buffer that having no current gain. However, the common-base transistor configuration has a high output impedance that isolates the cascode amplifier and prevents feedback into the cascode amplifier via transistors 310 and 316.

A second pair of common-base transistors, formed by transistors 312 and 314, is included in the example circuit 300. The second pair of common-base transistors 312 and 314 couples the collector of transistor 312 with the resistor 322 and the collector of transistor 314 with the resistor 324. As described above, the common-base configuration is a current buffer and does not amplify the read signal applied via the collectors of transistors 312 and 314. Thus, transistors 312 and 314 pull current away from the first common-base pair formed by transistors 310 and 316.

In this configuration, the transistors 310, 312, 314, and 316 are also configured as a current divider 326. In the current divider 326, current is shifted from the collector of transistor 310 to the emitter of transistor 316 via transistor 312. Additionally, current is shifted from the collector of transistor 316 to the emitter of transistor 310 via transistor 314. The amount of current shifted is based on the emitter size difference between the transistor shifting the current (i.e., transistors 312 and 314) and the intended transistors (i.e., transistors 310 and 316). To adjust the amount of current shifted by transistors 312 and 314, the bias applied to the bases of transistors 312 and 314 may be adjusted to selectively allow current shifting via transistors 312 and 314. As explained in detail below, by shifting currents, the current divider 326 may reduce the gain factor A_{O} of read signal provided via transistors 302 and 304 based on the bias applied to the bases of transistors 312 and 314. For example, the current divider 326 may reduce the gain factor A_{O} by 20%.

The output of the current divider 326 is formed by the collectors of transistors 310 and 316, which are coupled with a final stage of the example circuit 300 formed by transistors 330 and 332. The emitters of transistors 330 and 332 and coupled via feedback resistors (RF) 334 and 336 to current sources 338 and 340, respectively. The current sources 338 and 340 bias transistors 330 and 332. As illustrated in the example of FIG. 3, transistors 330 and 332 are configured as a common-collector pair. In the common-collector configuration, the collector of transistors 330 and 332 are coupled to the power supply 320 and the emitters of transistors 330 and 332 form the differential output of the gain circuit 202. Persons having ordinary skill in the art will ready appreciate that the common-collector configuration has has very little or no voltage gain. In other words, transistors 330 and 332 are voltage buffers that sense the voltages of the collectors of transistors 310 and 316 to present the voltages at the emitters of transistors 330 and 332.

In the example of FIG. 3, the feedback circuit 204 may be implemented by resistors 334 and 336 (R_{F}) to couple the output of the gain circuit 202 with the input of the gain circuit 202. More specifically, resistors 334 couples the emitter of transistor 330 with the base of transistor 302 and resistor 336 couples the emitter of transistor 336 with the base of transistor 304. Resistors 334 and 336 are configured to have substantially the same value, which is labeled as R_{F}. In this configuration, the example circuit forms a shunt-shunt feedback network that shunts a portion of the output of the example circuit 300 with the input of the example circuit 300. The feedback circuit 204, as described above, is a shunt-shunt feedback network that operates as a transresistance amplifier. In other words, the example circuit 300 may adjust the input impedance and the output impedance of the example circuit 300 based on parameters associated with the example circuit 300. More specifically, the input impedance of the example circuit 300 is given by the following equation:

$${Z}_{INPUT} = \frac{2 \times {R}_{F}}{1 + {A}_{O}}$$

where, R_{F} is the resistance of the resistors 334 and 3236 and A_{O} is the open loop gain of the gain circuit 202. Thus, in the example of FIG. 3, the input impedance is controlled by the gain factor A_{O} (the open loop gain) of the preamplifier 110 and the resistors 334 and 336. To determine the values of R_{F}, using the desired input impedance operating range (e.g., 40 to 50 Ohms) and the gain factor A_{O}, the optimal values of RF may be calculated on the input impedance equation described above.

Thus, in the example of FIGS. 2 and 3, the input impedance of the preamplifier 110 is controlled by the gain factor of the gain circuit 202. As described above, the gain circuit 202 adjusts the gain factor A_{O} based on the impedance presented by the read head 102 and the transmission line 104. In turn, the loop gain of the preamplifier 110 is affected and the input impedance changes with respect to the loop gain of the example circuit 300. FIG. 4 is an example diagram illustrating the input impedance of the example circuit 300 with respect to change in loop gain. As illustrated in FIG. 4, as the gain factor of the example circuit 300 increases, the input impedance of the example circuit 300 changes linearly. In other words, the example circuit 300 is a variable gain amplifier that presents a variable input impedance based on the gain of the example circuit 200.

In operation of the example of FIG. 3, the read signal from the read head 102 is conveyed to the bases of transistors 302 and 304 and the DC bias 318. When the output impedance of the read head 102 rises, the input impedance of the example circuit 300 rises to improve energy and signal transfer performance of the example circuit 300 (e.g., to flatten bandwidth performance). After receiving the read signal, the read signal is amplified by transistors 302 and 304 and conveyed to the emitters of transistors 310 and 316. The voltage the DC bias 318 applied to the transistors 312 and 314 also rises, thereby increasing the shifting a portion of the amplified read signal from the emitter of transistor 310 to the collector of transistor 316 via transistor 314. At the same time, transistor 312 shifts a portion of the amplified read signal from the emitter of transistor 316 to the collector of transistor 310. The read signal is differential and, therefore, the portions of the amplified read signal that are shifted from the emitters of transistors 310 and 316 are summed at the resistors 322 and 324. However, the amplified read signal is differential and the polarities of the read signal at the collectors of transistors 302 and 304 are inversely related. By shifting the current of the differential signal, the difference in the amplified read signal decreases, thereby reducing the gain factor A_{O} of the example circuit 300. As described in the input impedance equation above, decreasing the gain factor A_{O} increases the input impedance of the example circuit 300.

Similarly, when the impedance of the read head 102 falls, the example circuit 300 may lower the input impedance to improve performance of the example circuit 300. To lower the input impedance, the DC bias 318 decreases the voltage applied to the bases of transistors 312 and 314 based on the read signal. Thus, transistors 312 and 314 are driven lighter and shift less current. In turn, less amplified read signal is shifted from the emitter of transistor 310 and 316, thereby increasing gain factor A_{O} of the example circuit 300. As described in the input impedance equation above, increasing the gain factor A_{O} decreases the input impedance of the example circuit 300.

After amplification provided via transistors 302 and 304 followed by gain reduction provided via the current divider 326, the amplified read signal is conveyed to the output stage formed by transistors 330 and 332. As described above, the transistors 330 and 332 are voltage buffers and present the read signal on the emitters of transistors 330 and 332. A portion of the amplified read signal may be conveyed to the input of the example circuit 300 via the feedback resistors 334 and 336. In the example of FIG. 3, the feedback resistors (R_{F}) and the gain factor A_{O} configure the input and output impedances of the example circuit 300.

In addition, although certain methods, apparatus, and articles of manufacture have been described herein, the scope of coverage of this patent is not limited thereto. On the contrary, this patent covers all apparatuses, methods and articles of manufacture fairly falling within the scope of the appended claims either literally or under the doctrine of equivalents.

What is claimed is:

1. A method of varying the input impedance of a hard disk read preamplifier, comprising:
amplifying a read signal from a hard disk read head by a gain factor, wherein the gain factor is based on the read signal magnitude presented by the read head; and
changing the impedance presented to the read head based on the gain factor.

2. A method as defined in claim 1, wherein changing the impedance presented to the read head comprises dividing the read signal by a division factor.

3. A method as defined in claim 2, wherein dividing the read signal by a division factor changes the gain factor.

4. A method as defined in claim 1, wherein reducing the gain factor decreases the input impedance.

5. A method as defined in claim 1, wherein increasing the gain factor increases the input impedance.

6. An apparatus to vary the input impedance of a hard disk read preamplifier, comprising:
an amplifier to amplify a read signal from a hard disk read head by a gain factor;
a current divider to change the gain factor based on the read signal magnitude presented by the read head; and
an impedance modifier to modify the input impedance of the preamplifier presented to the read head.

7. An apparatus as defined in 6, wherein the amplifier is a common-emitter transistor.

8. An apparatus as defined in claim 8, wherein the amplifier is a cascode amplifier.

9. An apparatus as defined in 8, wherein the cascode amplifier comprises a first transistor and a second transistor.

10. An apparatus as defined in claim 6, wherein the current divider divides the current based on the read signal presented to the amplifier.

11. An apparatus as defined in claim 6, wherein the impedance modifier comprises a resistor.

12. An apparatus as defined in claim 6, wherein the impedance modifier comprises a feedback network.

13. An apparatus as defined in claim 12, wherein the amplifier and the impedance modifier form a shunt-shunt feedback network.

14. An apparatus as defined in claim 12, wherein the feedback network configures the input impedance.

15. A hard drive read system, comprising:
A read head form a read signal from a magnetic surface, wherein the read head communicates the read signal via a transmission line; and
an amplifier to receive the read signal, the amplifier having a first stage to amplify the read signal by a gain factor, a current divider to change the gain factor based on a magnitude presented by the read head, and an impedance modifier to modify the input impedance of the preamplifier presented to the read head.

16. A hard drive read system as defined in claim 15, wherein the current divider divides the current based on the read signal presented to the amplifier.

17. A hard drive read system as defined in claim 15, wherein the impedance modifier comprises a resistor.

18. A hard drive read system as defined in claim 15, wherein the impedance modifier comprises a feedback network.

19. A hard drive read system as defined in claim 15, wherein the amplifier and the impedance modifier form a shunt-shunt feedback network.

20. A hard drive read system as defined in claim 15, wherein the feedback network configures the input impedance.
